(19) United States
(12) Patent Application Publication
(10) Pub. No.: US 2005/0097613 A1
(43) Pub. Date: May 5, 2005

(54) Interactive personal service provider

(76) Inventors: Alberto Jose Raggio Ulate, Dallas, TX (US); Richard Dale Dean, Dallas, TX (US)

Correspondence Address: CARSTENS YEE & CAHOON, LLP, P O BOX 802334, DALLAS, TX, 75380, US

(21) Appl. No.: 10/700,022

(22) Filed: Nov. 3, 2003

(51) Int. Cl. H04N 7/173; G06F 13/00; H04N 5/445; G06F 3/00

(52) U.S. Cl. 725/86; 725/87; 725/46; 725/45

(57) ABSTRACT

The proposed invention is an apparatus and method that enables video communication through a studio that is placed in a public location whereby a studio user records a performance, presentation, or an interview. In one embodiment, information seekers with special interests may view interviews or presentations recorded by studio users pertaining to subject matter relevant to that special interest. In one embodiment, a performance is recorded and uploaded to the Internet where the general public locates and views the performance. In an alternative embodiment, the performance is rated.

### BACKGROUND OF THE INVENTION

1. Technical Field

The present invention relates to a method and apparatus for providing performance, presentation, or interview services in publicly accessible locations, whereby a performance, presentation, or interview is recorded to satisfy an informational, entertainment, or personal need of the recorder, a viewer, and/or an information seeker.

2. Description of Related Art

Historically, the flow of information was paper-based. However, this is inadequate where one would like to assess another's or convey one's demeanor, truthfulness, talent, presence, responsiveness, ability, maturation, looks, professionalism and/or confidence. There are numerous instances in which business needs go unfulfilled because of the difficulty in articulately conveying a message through written communication. Often, an interview, presentation, or performance is far more powerful when delivered in an audio/video format.

The importance of interviews, for example, is illustrated by conventional hiring practices. Job prospects are rarely hired based on their resume alone, but must often interview for their position. Similarly, interviews are often an important part of the college admissions process. This is because evaluating job or college applicants in a visual manner enables assessment of one's demeanor, truthfulness, talent, presence, responsiveness, ability, motivation, professionalism, and/or confidence. It is now commonplace as a result of modern communication and the advent of the Internet for qualified job applicants to locate positions in other cities. Likewise, it is common for employers to scour the entire country for qualified job applicants. However, it is very time consuming for applicants to travel to interviews. Traffic congestion in cities is common. Airlines frequently require arrival several hours before flight departure further expanding the required travel time. In addition, travel and associated costs such as lodging, car rental, and meals is expensive. Oftentimes an interviewer may be able to quickly size up an interviewee, yet feel compelled to spend more time than needed on an interviewee because of the investment made in attending the interview. As a result, additional precious time of the parties is spent inefficiently.

Information gathering via focus groups, rather than questionnaires, is a preferred method used to assess the frank reactions of consumers on a wide variety of topics. Physically observing consumer feedback about new or existing products provides a marketer or manufacturer with a flavor of the intensity of consumer sentiment toward a product or service. Intensity of people's reactions may also be important when obtaining polling data. But, information gathered for consumer feedback or polling often varies by geographical location. It is often desirable to obtain data from a cross-section of the country to ensure a more representative sampling. Additionally, it may be desirable to target specific far-away locales.

Testimony is another example of desirable non-paper based information flow. By its very nature, the veracity of testimony cannot always be determined from a transcript, and because of this fact, it is firmly rooted in American courts that a trial judge or jury observing testimony be given wide discretion to assess the weight of the truthfulness of the testimony rather than a reviewing court who sees only a paper transcript.

As illustrated by the foregoing examples, it is often desirable to have visual communication any time there is a need to exchange information through a question and answer format or an interview. Thus, a need exists for a method and apparatus to enable people to record an interview at a nearby or convenient location and have the opportunity to have such interview stored and categorized so it may be easily located and viewed by a target audience, for example an interviewer.

A second example of a format where visual information exchange is vital is a presentation. The importance of presentations can be illustrated by people in need of bone marrow or kidney transplants who often must wait anxiously for a compatible donor. Visual, personal stories of people in distress are likely to elicit a compassionate response from those watching. The visual impact of a needy donee, along with his or her family, may provoke a willing donee to learn if he or she is a compatible donor thus increasing the likelihood of a compatible donee-donor match.

Presentations are important for entrepreneurs competing against others to raise money for venture capital ideas. Many entrepreneurs have a contagious vigor, excitement, and energy that can only be conveyed in person or by video. Boring, number-intensive business plans do not necessarily convey the energy and drive that so often translates into a successful business. Further, it is both costly and time consuming for entrepreneurs to locate, travel to, and meet with every venture capitalist that has the financial strength to fully fund his or her project. Likewise, it is time consuming for venture capitalists to sort through the many business ideas that are presented to them and separate the good from the bad. Thus, a need exists for a method and apparatus to enable people to record a presentation at a nearby or convenient location and have the opportunity to have such presentation stored and categorized so it may be easily located and viewed by a target audience.

A third example of a format where video communication is highly desirable is auditions and performances. Performances and auditions are of utmost importance in the talent industry. It has been estimated that about ten percent of the total ten to fifteen million people who reach teen age every year would like to be recognized for their talent. It has also been estimated that five percent of the total thirty million people in the age group of fourteen to twenty-five look for opportunities to promote their talent. These estimates are evidenced by the thousands of people who turn out for auditions for the popular Fox television series “American Idol” where unknown artists have the opportunity to be seen by millions of viewers and potentially enter the very lucrative entertainment market. Talent agencies earn over ten billion dollars annually to search and promote young talents. Hiring a talent scout, however, is very expensive and there is no guarantee that the talent scout has the right connections. In addition, because the talent scout is often promoting numerous known or unknown artists to the same casting directors or record labels, there may be an inherent conflict of interest. Moreover, the aspiring, unknown artist may be limited by his or her talent scout's ability to sell.

One approach an amateur artist may take in attempting to climb the ladder of success is to approach it individually. Unfortunately, this approach is undesirable because it is expensive for an unknown artist who tries to work on his own to, for example, record and send multiple demo tapes to numerous record labels or attend numerous auditions set up by casting directors. Such an approach is also disadvantageous to record labels because just listening to demo tapes is a time consuming, and thus expensive, process. Moreover, in times past, so many artists sent in demos that it became impossible for those responsible for finding new talent, the artist and repertoire (“A&R”) people at the record labels, to keep up. As a result of the sheer volume of tapes sent in, the cumbersome nature of loading and unloading each individual tape, and other legal issues, few labels now listen to unsolicited demo tapes sent in by artists. Rather, the A&R people now typically rely on trusted business sources to send them good talent. Unfortunately, few lay artists know who these trusted business sources are or where to find them. Absent discovery from the A&R people, there is literally no chance for an unknown artist to be signed by a major record label. Even if the A&R people hear something they like, the A&R people have no way of knowing, other than their own best guess, whether a recording would be popular with the public without first investing money in production, promotion, marketing, distribution, and monitoring of sales. Thus, a need exists for a direct median to inexpensively determine a performer's marketability.

Like a job applicant who interviews in person or an entrepreneur who gives a presentation in person, one approach that may be used by an amateur artist is to audition in person for a role. But like interviews and presentations, the use of auditions to find talent for a television show, a commercial, or a movie also has several drawbacks to both artists and talent seekers. First, the bargaining power of the unknown artist is very low because of the relatively few market players on the talent-seeking side. Thus, the talent seeker's offer is usually made on a take it or leave it basis. Second, many artists do not have the time required to stand in line and wait for an audition. Third, many artists may not be knowledgeable about audition opportunities or may not live near an audition location. Fourth, the opportunity to take part in such an audition may be extremely limited, especially in light of the artist's time commitments with school or work. In addition, an unknown artist's financial situation may limit his or her opportunity to travel to an audition location. Fifth, talent seekers must spend large sums to run large-scale nationwide auditions every time there is a need to fill a requirement for new talent. Thus, running auditions is time consuming and expensive. These same drawbacks exist in other instances where written communication fails to enable a talent seeker to evaluate one's demeanor, truthfulness, talent, presence, responsiveness, ability, looks, motivation, professionalism and/or confidence. Thus, a need exists for a method and apparatus to enable people to record a performance at a nearby or convenient location and have the opportunity to have such performance or audition stored and categorized so it may be easily located and viewed by a target audience.

With the advent of the Internet, an unknown artist can use the Internet to reach a large segment of the general public as well as talent scouts, casting directors, and record labels who may be looking for talent. For example, Chacker (U.S. Pat. No. 6,578,008 B1) discloses a method and system for implementing an on-line talent business whereby large numbers of unknown artists can have their artistic works voted on by the public. Then, the on-line talent business enters into business contracts with the artists based on public voting. However, the prior art approach described by Chacker requires an aspiring, unknown artist to procure an audio or digital video file of themselves in the proper computer format which then must be uploaded to the website as disclosed in Chacker. Digital audio and video recording equipment is very expensive and many people simply do not have the expensive software and costly hardware required to capture quality audio sounds and video images and transform them into the required computer compatible media. Furthermore, even if such hardware and software were widely available, the artist would have to spend precious time to learn how to use it. This is inconvenient, time consuming and thus undesirable.

Another prior art approach is disclosed by Frey et al. (U.S. Pat. No. 6,369,908 B1), which enables a user to digitally capture video images and either save them locally to a removable electronic storage device or email the image to an end user. This prior art approach, however, fails to upload the digital image to a website for viewing. In addition, this prior art approach does not enable a viewer to easily locate and view video files based on his or her interest.

Another prior art solution that attempts to enable video communication between parties is disclosed by Hogan et al. (U.S. Pat. No. 5,872,922), which is a video conferencing platform. For a consumer to use this software, however, would require him or her to obtain the equipment, learn how to use it, and schedule a time when another person would be available for two-way video conferencing. This prior art approach fails to enable a user to conveniently engage in videoconferencing without owning or acquiring the equipment and spending valuable time trying to figure out how to operate it.

Similarly, Pena (U.S. Pat. No. 6,292,211), discloses a system and method of video communication between two remotely located people using the Internet. However, this prior art approach is requires at least one skilled technician to set up the system each time a set of subscribers wants to use the system. Thus, this is a labor-intensive and thus expensive way to conduct videoconferencing.

Therefore, there is a need for an efficient method and apparatus for conveying countless interview, presentation, and performance situations in a visual form. As illustrated by the examples above, there are instances when in-person visual communication is highly desirable, yet cost prohibitive. This is because in addition to production costs, there are other costs associated with compatible parties sorting through and finding one another, and the costs, such as time, travel, and lodging, associated with the compatible parties engaging in an information transmission. Consequently, a need exists for a method and apparatus to enable people to record an interview, a presentation, or a performance at a nearby or convenient location and have the opportunity to have such interview, presentation, or performance stored and categorized so it may be easily located and viewed by a target audience at a time convenient to that audience. In sum, an interactive personal service provider is needed that is capable of providing video communication that is adaptable to the many diverse needs of various people or businesses.

### SUMMARY OF THE INVENTION

The present invention is a method and apparatus for conveying, through video communication, information through an interactive personal service provider. In one embodiment, the invention comprises a studio in a public place that enables at least one person or studio user to record a performance, categorize the performance by subject matter, and upload the recorded performance to a website where it can be viewed by an information seeker and/or a viewer. Categorizing the recording by subject matter enables a target audience of viewers and information seekers to easily locate the recordings that they are interested in viewing. There are a number of different subject matter categories that can be recorded including, but not limited to interviews (e.g., job placement, college admissions, consumer feedback on product or service, dating, accident investigations, video depositions, legal case screenings, auditions, polling, etc.), presentations (e.g., small business infomercials, entrepreneur, medical needs, messages to far away friends, family, or troops), and performances (e.g., talent search for music, casting, modeling, comedians, and magicians).

In one embodiment of the invention, studio users enter a studio in a public location, such as a shopping mall, categorize and record at least two performances in private, preview the recorded performances, select a performance, and transmit the selected performance to a website where the performance is viewed by the target audience. The apparatus and method thereby enables a studio user to have his or her performance, presentation, or interview viewed by a target audience at minimal overall cost and with minimal knowledge of computer software and hardware operation.

In an alternative embodiment of the invention, the apparatus and method enables a studio user to have his or her performance, presentation, or interview viewed and rated by the general public and potentially seen by talent-seeking entities.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1a is a block diagram of one embodiment of the invention;

FIG. 1b is a block diagram of a menu system in accordance with an embodiment of the invention;

FIG. 1c is a block diagram of services that may be provided in accordance with an embodiment of the invention;

FIG. 2 is a perspective view of a studio in accordance with an embodiment of the invention;

FIG. 3a is a cut-away perspective view of the inside right panel of a studio in accordance with an embodiment of the invention;

FIG. 3b is a cut-away perspective view of the inside left panel of a studio in accordance with an embodiment of the invention;

FIG. 3c is a cut-away perspective view of the top of the studio in accordance with an embodiment of the invention; and

FIG. 4 is a flow chart depicting the flow of data in accordance with one embodiment of the invention.

### DETAILED DESCRIPTION

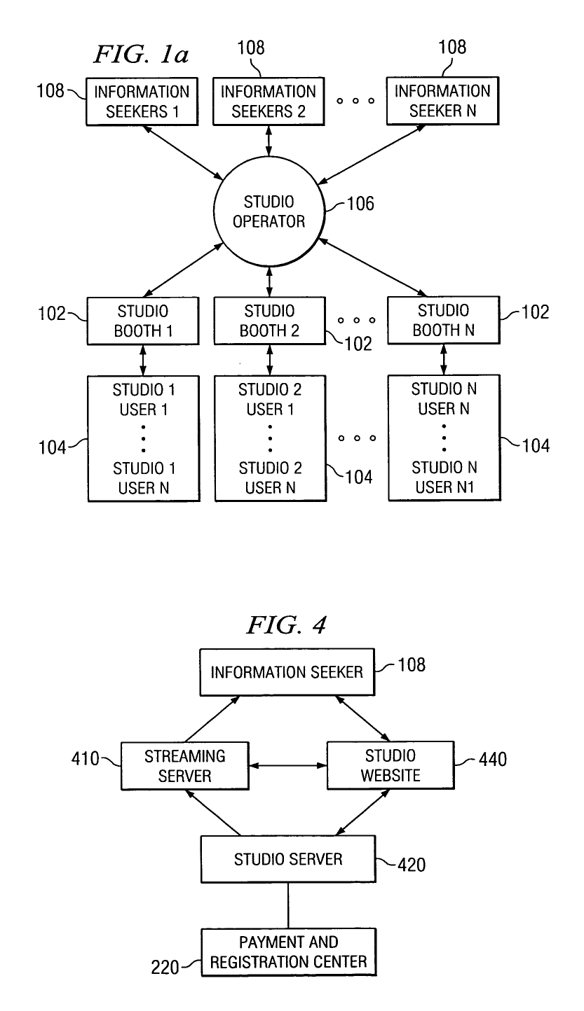

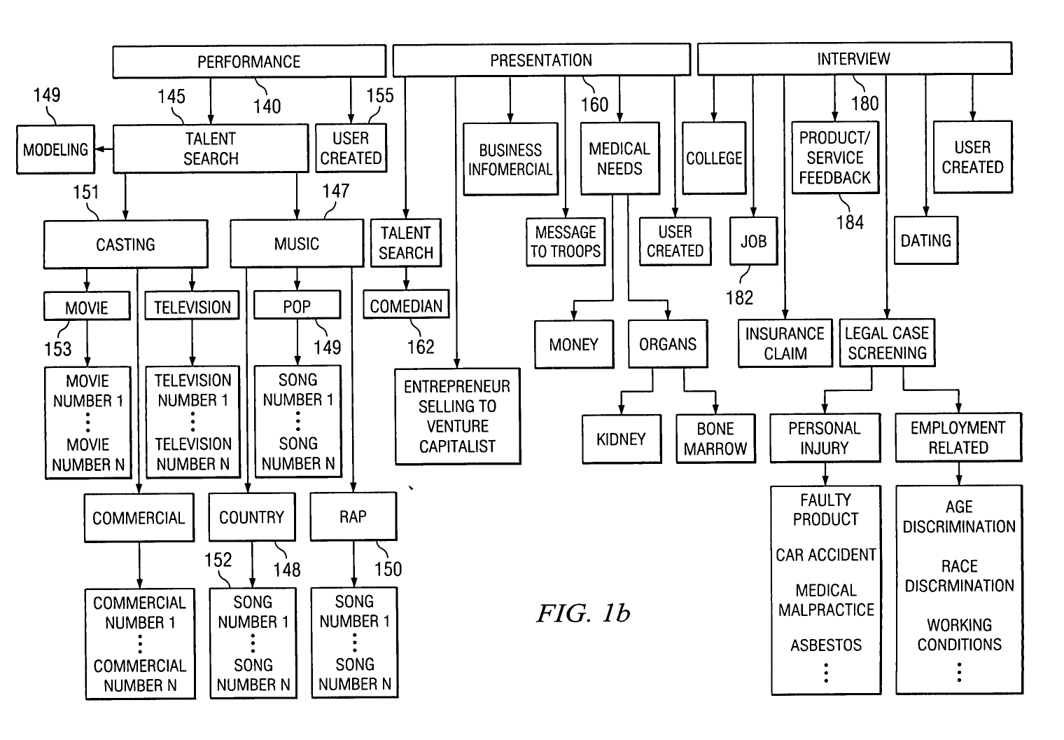

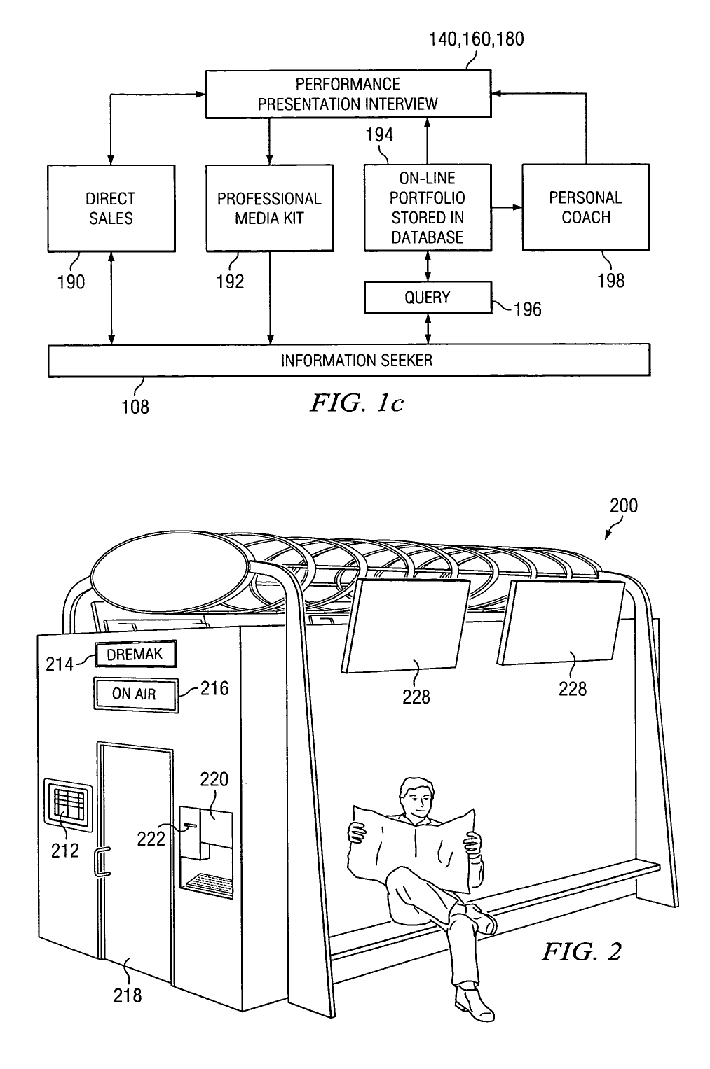

The present invention, an interactive personal service provider shown in FIG. 1a, provides in one embodiment, a studio 102 in a public place that enables at least one person, defined herein as a studio user 104, to record a video, categorize the video based on its subject matter, and upload the video to a site maintained by the studio operator 106 where it can then be viewed by an information seeker 108. An information seeker 108 is a person or entity that views the recorded video to achieve a certain purpose. The purpose may include, but is not limited to, such endeavors as seeking or evaluating talent, personal entertainment, evaluating potential employees, evaluating potential donation needs, evaluating potential investment opportunities, evaluating consumer feedback of products or services, evaluating a potential legal case, etc.

FIG. 1b is a block diagram of a menu system in accordance with an embodiment of the invention. This block diagram could be implemented as a menu system for the interactive personal service provider described below. As illustrated in FIG. 1b, the performance 140, presentation 160 and interview 180 categories enable studio users to make recordings of diverse subject matter. For example, from the performance category 140, a studio user may further narrow and categorize the subject matter to be recorded into a talent search category 145. The talent search category 145 may be furthered narrowed into pre-determined sub-categories such as music 147, modeling 149, and casting 151. This narrowing could continue until the subject matter of the recording is accurately defined. There could be unlimited subsets of sub-categories within sub-categories. For example, under the talent search category 145, within the sub-category music 147, there could be more specific sub-categories including, but not limited to, country 148, pop 149, or rap 150. Moreover, if a pre-determined sub-category failed to define the subject matter of the recording, the studio user could create a user-defined category 155 and/or sub-category. This categorization allows studio users to place their recordings such that a target audience may effectually locate and view the recording. Below, different services available by use of the invention are described in greater detail. However, these different services are shown for illustration and not limitation.

FIG. 1c is a block diagram of services that may be provided in accordance with an embodiment of the invention. A studio user or the studio operator may use the recorded performances 140, presentations 160, or an interviews 180, for any number of purposes. As used herein, the terms presentation and interview are included within the definition of performance. For example, the studio operator could select the best comedy acts recorded in the studio and provide a mechanism for direct sales 190 to information seekers 108. The mechanism could comprise placing the selected acts on a DVD and selling the DVD or allowing people to download the acts for a fee. A professional media kit 192 could be produced using recorded images or information input during registration. The professional media kit could be created by a hired professional or by the studio user. The professional media kits 192 could then be sent to information seekers 108 including, but not limited to, talent scouts or employers. A studio user could create an on-line portfolio 194 that is stored in a studio sponsored database. For example, an actor who is not selected for casting role auditioned for may keep his or her demographic information and performance in a database that can be queried 196 by casting directors or other information seekers 108 in the future. In one embodiment, a studio user pays a subscription fee for the portfolio service. In one embodiment, an information seeker 108 pays a fee to search or query 196 the database 194. Thus, in such an embodiment, the casting director need not place a script for audition with the studio operator, but the casting director (e.g. information seeker 108) could query 196 for a specific need. For example, the casting director could query 196 for a specific male or female actor with a specific trait including, but not limited to, height and weight, or a desire to play in dark dramas and who has a performance stored in an on-line portfolio database 194. The actor could have noted in his or her account that a casting director requested his or her profile and optionally what his search criteria (query) 196 was. This information could be emailed to the actor.

Studio users could have a personal coach 198 review the on-line portfolio 194 and offer tips the studio user can implement to improve his or her recorded performances 140, presentations 160, interviews 180, or input registration information and enhance his or her chances of making a match with an information seeker 108. For example, a studio user who records an interview 180 as part of a dating service and has the interview stored in an on-line portfolio 194 for purposes of finding a compatible mate, may encounter few or no responses from other mate seekers' 108 queries 196. The studio user could have a personal coach 198 review the studio user's on-line portfolio 194 and offer tips relating to dress, demeanor, or attitude. Then studio user could then re-record a new interview 180 that could be stored in the on-line portfolio 194. Likewise, aspiring actors could have their performance enhanced with tips from a personal coach 198. The personal coach 198 could be useful in some way for every performance 140, presentation 160 or interview 180 in every service shown on FIG. 1b.

Referring to FIG. 1b, recordings are categorized based on its subject matter classification and/or associated database information specifically input by the studio user during registration for pre-screening. The recordings and associated registration data are categorized in such a way that the internet user/viewer and or information seeker will be able to narrow his or her subject matter specific search to a fraction of the time it would take to sift through all the recordings. For example, an information seeker's search may be for actors, comedians, performers, job seekers, organ donors, venture capitalists or simply for information descriptive of a studio user. In any event, the rewards to an information seeker could be enormous if he or she were able to efficiently find and secure performers, presenters, or interviewees using the large database of subject matter specific talent assembled and illustrated through the performances, presentations, or interviews recorded in the interactive personal service provider. This large database of talent, referred to herein as a “Personal Multi Listing Service,” will be beneficial to both the individual studio user as well as the individual information seeker because the information or talent seeker will be able to access the Personal Multi Listing Service to make a query for talent or other information. This information will be categorized based on subject matter or studio user input such as demographic information. It will provide extensive profiling which will offer deep querying capabilities. This will increase the opportunities and exposure of the studio user and likewise allow the information seeker and studio user to efficiently locate one another. The studio user and information seeker may then together exploit the synergy of their relationship.

In an alternative embodiment, viewers rate the performance, interview, or presentation to help guide the information seeker who may otherwise be overwhelmed with recordings. In a ratings embodiment, a viewer is defined as anyone with access to an Internet connection. Thus, the general public rates a studio user's performance. In addition, an information seeker, in this alternative embodiment, is a person or entity that is capable of exploiting talent. In a non-ratings embodiment, an information seeker and a viewer are synonymous and can be defined as a person or entity that views the recorded video to achieve a certain purpose. A ratings embodiment in a talent search setting is discussed next in greater detail.

Performance—Talent Search with Ratings

FIG. 2 is a perspective view of a studio in accordance with an embodiment of the invention. In one embodiment, a touch screen monitor 212 is used to enable a studio user to access a menu system such as the one illustrated in FIG. 1b. For example, using the touch screen menu, the studio user would select the performance category 140. The studio user would then be shown all the sub-categories within the performance category 140. Continuing with this example, the studio user selects the talent search sub-category 145, and then the music sub-category 147, followed by the country category 148. A list of all the songs available in a Karaoke-style database would then be listed on the touch screen monitor. A code, or number, could be shown next to each song. A studio user could memorize or write down the number corresponding to the desired song. This number could then be input during registration (described below). In another embodiment, the menu system displayed on the touch screen monitor would be accessible in other places including, but not limited to, brochures, a server, or a website. In other embodiments, the menu is accessible at the payment and registration center 220 as shown by FIG. 2, and a desired song or other subcategory can be selected during registration.

To use the studio 200, an aspiring, unknown artist or studio user may register in the first step at the payment and registration center 220. The unknown artist may submit payment in the second step. Registration comprises the artist or person selecting his future recording from a subject matter specific category by selecting the “Talent Search” category 145 (as shown in FIG. 1b) and applicable sub-category on an interactive screen and inputting personal and/or demographic information into a computer database. As discussed above, during registration, the type of performance, interview, or presentation the studio user would like to record is input from a list of special interest categories that are pre-determined. The invention also allows the studio user to define a category that describes the subject matter pertaining to his or her recording. Information input during registration could include physical attributes of the artist including, but not limited to, height, weight, age, sex, and hair and eye color. Personal attributes such as marital status, email address and mailing address could also be input during registration. This input information would then be stored in a database to enable a talent seeker, information seeker or other target audience, to pre-screen for specific needs.

The talent seeker can be a person or entity capable of more fully exploiting undiscovered talent and includes, but is not limited to, talent scouts, casting directors, record labels, and job placement coordinators. In one embodiment, the artist's input information is not accessible to the general public. In addition, the artist may be required to agree during registration that the studio operator shall be the artist's exclusive agent. This exclusive agency contract ensures that only the studio operator can contact the artist regarding the artist's performance. The exclusive agency contract is beneficial to the artist because it prevents contact with potentially unreputable or overly exploitative talent seekers.

After registration, the unknown artist enters the studio in the third step and records a performance in step four. In one embodiment, the artist is permitted to repeat this fourth step of recording the performance and records at least two performances. In another embodiment, the artist performs “practice runs” which go unrecorded, and then records his or her final performance. The artist then previews the recorded performance in step five and selects one performance to upload in step six. Some recorded performances, such as presentations and interviews, may be more conducive to only having the final performance recorded. After the performance is uploaded, but before the performance can be rated, the artist may be required to log into a website set up by the studio operator to finish or more fully complete his or her profile. This requirement may be desirable if the studio user or artist is under age 18 because it would provide an opportunity to ensure proper parental consent. This requirement is also advantageous because it minimizes the time an artist spends at the payment and registration center 220, as shown in FIG. 2, and thereby eliminates a potential bottle neck and enables more artists to audition in the studio 200.

In one embodiment, the studio operator website employs a ratings system whereby viewers, as reviewers, rate the performance by, for example, assigning the performance a value on a scale of one to ten. Such Internet ratings systems are well known in the art as exemplified by www.ratings.net. The ratings system employed by the website prevents multiple votes by the same viewer by a number of methods known in the art including, but not limited to, requiring the Internet user/viewer to register and obtain a user identification code and password and/or by using “cookies” to track computers that have already voted on a certain artist and performance. The ratings could be openly viewed on the Internet by the general public. Reviewers may also be rated by fellow reviewers. This may add enjoyment to the process reviewing artists because a reviewer can see how highly others regard his or her rating and strive to achieve more accurate ratings. Next, the record label or other talent seeker can access the ratings. The record label or talent seeker can then make a deal with an unknown artist with a rating knowing that the artist's talent has already been market-tested. Thus, by use of this invention, people who may have never been recognized for their talent are able to rise to the top.

In an alternative embodiment, the recordings are not rated but are instead viewed directly by the information seekers, such as A&R people at record labels. Because the recordings are organized by category (categorized) and in digital format, and because the information the artist provides at registration will enable an information seeker to query for a specific demographic, A&R people may quickly view the artists to fill a need. Moreover, the A&R people can quickly, via computer, view numerous studio users without fumbling with cumbersome video or audiocassette tapes. In addition, there are fewer potential legal complications if an artist signs an agreement during registration prior to his or her recording. For example, each artist may be required to certify that he or she is over 18 or has the approval of an adult. Because of the efficiency that this invention provides, record companies could again accept direct submissions from artists.

In one embodiment, the studio 200 is completely enclosed to enable a studio user such as an unknown artist to audition, perform, interview, or make a presentation in private. In an alternative embodiment, the studio 200 is open on one or more sides to enable the unknown artist to perform in view of an audience. The studio 200 can be placed in public places including, but not limited to, shopping malls, movie theaters, sports arenas, college campuses, entertainment venues, state and county fairs, or any other public place. The studios can be made such that they are easily moved from one place to another or could be permanently affixed.

In the embodiment as shown in FIG. 2, the studio 200 has a touch screen monitor 212, a sign 214, some type of “in use” or “on air” indicator 216, a door 218 and messaging monitors 228. A custom studio purchased from Acoustic Systems of Austin, Tex. can be used. In one embodiment, the messaging monitors 228 can be used for advertising to third parties to reduce costs to aspiring, unknown artists to use the studio 200. Messaging monitors such as a Panasonic 42″ model number TH42PWD6UY plasma screen monitor available from Plasma Advantage of Birmingham, Mich. can be attached to the studio 200. In an alternative embodiment, the messaging monitors 228 can be used for studio-specific announcements and advertising. For example, a casting director accepting auditions from the studio 200 for a new movie may place the relevant information on the messaging monitors 228 through the studio operator or advertisements for a job opening (discussed below). A looping program designed to excite and attract patrons could be run. Instructions on how the studio operates could also be displayed.

Performance—Talent Search—Music

One embodiment of a menu that could be used and shown as FIG. 1b may be displayed on the touch screen monitor 212. From the menu, a studio user or artist selects the “Performance” category 140. A menu driven list of pre-determined categories including “Talent Search” 145 as shown on FIG. 1b, is then displayed. Following selection of “Talent Search” 145 sub-categories such as “music” 147 and “casting” 151 are listed. Following selection of “music,” 147 from a sub-category list and further selection of “country,” 148 from another sub-category list, all the country music songs available in a Karaoke-style database are then listed on the touch screen monitor 212. A Karaoke system such as model number CAVS JB-99 manufactured by CAVS USA in Santa Fe Springs, Calif. can be used. In one embodiment, each song has an associated number, which the artist memorizes or writes down. In such an embodiment, the associated number is then input later on when the studio user registers. The subject matter available on the touch screen monitor may also be accessed on a studio sponsored website so that the studio user can pick the song before arriving at the studio.

The studio 200 is equipped with a payment and registration center 220 comprising a computer system and payment acceptance device that accepts payment including, but not limited to, cash, debit cards, credit cards, third party billing codes, and combinations thereof. A third party billing code allows partial or full payment to be made by a party other than the studio user. Payment may be made by inputting credit card information or a third party billing code from the payment and registration center 220 wherein the payment and registration center 220 is connected to the studio sponsored site. Following registration, the artist may pay (if payment is required) at the registration and payment center 220 provided on the outside of the studio. The registration and payment center 220 may optionally be located inside the studio 200. In addition, the touch screen monitor 212 may be combined with the payment and registration center 220 either inside or outside the studio.

In one embodiment, payment and registration are performed remotely. This allows a studio user to select their category and pay for it prior to going to the studio location. For example a studio user accesses the studio operator website and submits payment information such as credit card information, and registration information, such as demographic information. The studio user then prints out a receipt with a barcode that is readable by the bar code reader at the registration and payment center 220 or inside the studio.

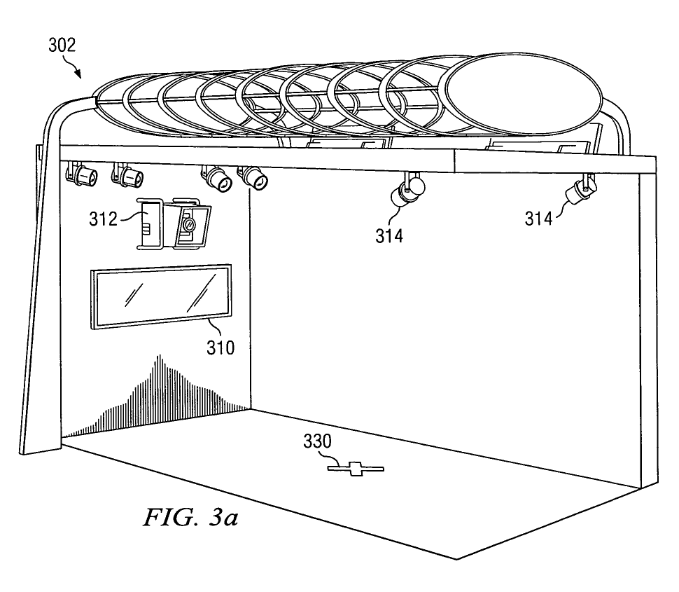

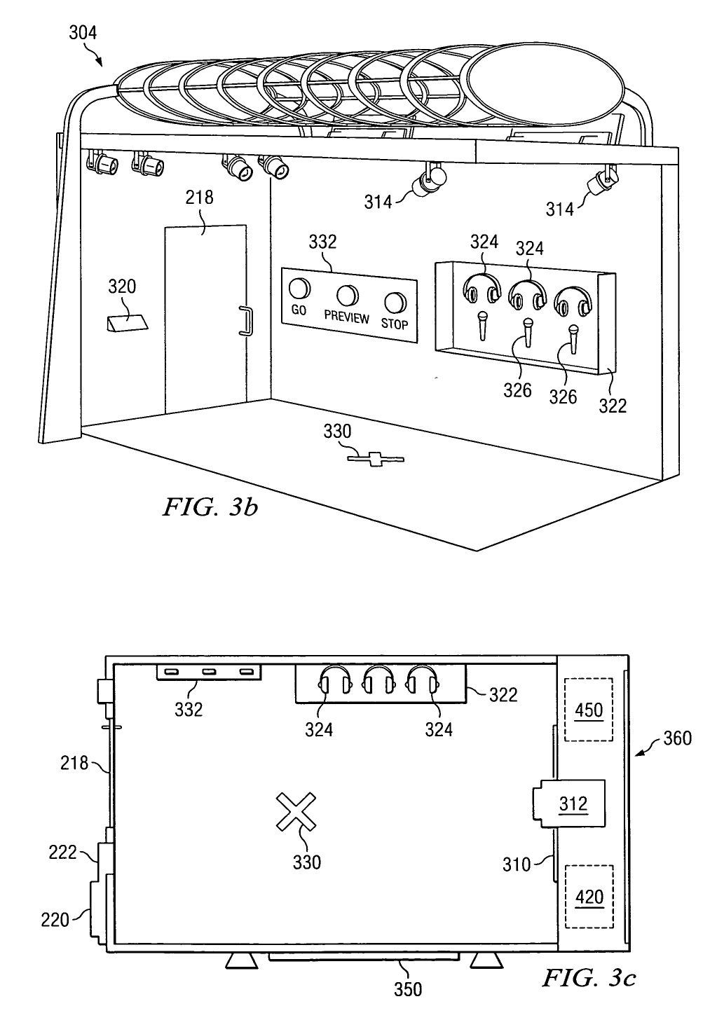

Upon entry into the studio, an audio voice, which in one embodiment is a female voice with an English accent, instructs the artist how to proceed. FIG. 3a is a cut-away perspective view of the inside right panel of a studio in accordance with an embodiment of the invention. FIG. 3b is a cut-away perspective view of the inside left panel of a studio in accordance with an embodiment of the invention. FIG. 3c is a cut-away perspective view of the top of the studio in accordance with an embodiment of the invention. For example, referring to FIGS. 3a, 3b, and 3c, the audio voice instructs the artist to, “please look to your right and walk up to the bar code reader 320, and scan your receipt obtained during registration.” Once the receipt is scanned, the registration information is downloaded to the studio server, which transfers the performance category information to the audio/video server 450. The audio/video server automatically runs the proper computer program to conform to the category the studio user selected during registration. For example, when the selected subject matter is a talent search for music, the artist, after scanning the receipt at the bar code reader 320, is greeted and guided through the process by an image of a producer/sound mix engineer that appears to be seated in a recording studio control room. This image can appear on a video/teleprompter screen 310 shown in FIG. 3a. The producer/sound mix engineer's audio voice may inform the artist that he or she will be able to hear his or her song using the headphones 324 located on the wall as shown in FIG. 3b. The system may also inform the artist that even though he or she can hear the music through the headphones 324, only his or her raw voice will be recorded for the performance or audition. The system may also instruct the artist to use a microphone 326 and to place the headphones 324 on his or her head. The headphones 324 may be designed to minimize potential feedback produced by the microphone 326. Next, the audio voice may prompt the artist to press the “GO” button on the control panel 332 when ready to start the performance. Then, the audio voice may instruct the artist to walk to the X 330 located in the middle of the studio. The audio voice may inform the artist that he or she will have two short warm-up sessions prior to one real audition that will be his or her final audition. Referring to FIG. 3a, the voice will tell the artist that the lyrics or words to the chosen song will appear on the video/teleprompter screen 310 near the camera 312. Next, the audio voice informs the artist to touch the “GO” button on the control panel 332. This activates a simultaneous audio countdown in the headphones 324 and a visual countdown on the video/teleprompter screen 310 next to the camera 312, and informs the artist that one minute between the two warm-up sessions is available to practice, and that when the third session begins, the artist will have 2 minutes to record his or her final audition. The number of warm-up sessions and recording time specified here is for illustration only and is not meant to limit the number of warm-up sessions or the practice or recording times.

Once the artist touches the “GO” button on the control panel 332 the video/teleprompter screen 310 next to the camera 312 commences a countdown from, for example, 10 to 1, as the indicated time elapses. After the countdown, the music plays in the headphones 324, and the lyrics or words appear on the video/teleprompter screen 310. The artist then performs for about 1 minute. The music then stops and an audio voice indicates it is almost time for warm up number 2. Next, the countdown starts again from 10 to 1. Following the countdown, the music starts in the headphones 324, words appear on the video/teleprompter screen 310, and the artist performs and warms up for another one-minute session. After the last word on the video/teleprompter screen 310 is shown, the audio voice will inform the artist that his or her recorded audition is about to begin. In one embodiment, the voice compliments and encourages the artist. Next, the countdown from 10 to 1 begins. When the countdown reaches 5 the camera lights 314 illuminate and the words “LIVE ON THE AIR” appear near the camera. In an alternative embodiment, the same or similar message is shown on the indicator 216 on the outside of the studio 200 as shown by FIG. 2 and is activated upon entry into the studio. Referring back to FIGS. 3a and 3b, when the countdown reaches 1 the music starts, the words appear on the video/teleprompter screen 310 and the artist performs to the music transmitted through the headphones 324, and records his or her audition, or performance. In one embodiment, as the artist performs, the artist simultaneously views his or her performance on video/teleprompter screen 310.

Once the 2-minute performance is finished, the audio voice compliments the artist and informs the artist that his or her performance can be previewed at the video/teleprompter screen 310. Following the preview, the artist may submit his or her recording. In one embodiment, the artist is given the option of immediately watching his performance on the video/teleprompter screen 310, or at an outside studio viewing area 350 as shown in FIG. 3c, or later by accessing the studio site from the internet. In one embodiment, the artist is informed that submission enables it to be viewed by thousands of viewers who will rate the talent and give the artist a fair chance at stardom. In an alternative embodiment, the computer screen then reminds the artist to visit the studio web site to finish his or her profile so his or her recording can be viewed and rated. Next, the audio voice thanks the artist and wishes him or her luck. The audio voice also reminds the artist to return the headphones 324 and microphone 326 to the storage rack 322. An email is sent to the studio user to remind him or her to finish his or her profile, view his or her performance, manage his or her profile, or see his or her rating.

FIG. 3c is a cut-away perspective view of the top of the studio in accordance with an embodiment of the invention. In one embodiment, each studio comprises two servers. One server is an audio/visual server 450 and controls the lighting 314, the camera 312, and the video/teleprompter screen 310. The second server is the studio server 420 which is used to process payment and registration as well as door access. Although one server could handle all the studio needs, at least two servers may be used to provide back-up redundancy. Thus, if one server fails, the other will take over all operations. In one embodiment, a secure access panel 360 provides easy, access to the servers. In one embodiment, a viewing area 350 is placed outside to enable a studio user's performance to be broadcast on the outside of the studio. The studio user's performance could be broadcast either live, while the performer was inside the studio, or following the performance. Additionally, in a preferred embodiment, the studio is equipped with a ventilation system (not shown) to keep the inside cool and comfortable and soundproofing wall panels (not shown).

FIG. 4 is a flow chart depicting the flow of data in accordance with one embodiment of the invention. As shown in FIG. 4, the payment and registration center 220 inputs information to the studio server 420, payment information is verified, a profile is created and an account and log-in information such as a user name and password is created. The payment and registration center 220 prints out 222 the information along with instructions. A bar code may be printed out on the receipt. After payment and registration, an unknown artist will proceed inside the studio to prepare for the performance. In an alternative embodiment, a studio user submits payment and registers at the studio site 440. In one embodiment the studio site 440 is a studio-sponsored website. In an alternative embodiment (not shown), the studio site is a “brick and mortar” physical location where information seekers 108 may view recorded performances. Thus, while some embodiments of this invention may use internet connections, the internet is not a required element of this invention.

Performance—Talent Search—Casting

In the talent search casting service, a studio user, in this case an actor, pays and registers as discussed above. However, rather than selecting music 147 from the menu shown in FIG. 1b, the actor selects the casting category 151, or other similar option. A casting director for a movie could request the studio operator to place scripts or other instructions for specific parts in specific movies such that a new menu item is created. The actor may have the opportunity to access the subject matter, including scripts, from the studio site prior to payment and registration. This would enable the actor to practice the song or script until the actor was comfortable prior to his or her audition or performance in the studio. All the casting and other opportunities could be available for preview from a studio server or studio site. In one embodiment, the actor could access and preview the opportunities from the Internet.

Following payment and registration, the actor enters the Studio and an audio voice instructs the actor to scan the bar code on his receipt at the bar code reader 320 as discussed for previously selected subject matter. Once the receipt is scanned, the studio server automatically runs the proper computer program to conform to the category and sub-category (here casting) the studio user selected during registration. The actor may be greeted by an image on the video teleprompter screen 310 of a Los Angeles type director and cameraman surrounded by movie set props and equipment. The director instructs the actor on the audition process. For example, the director's audio voice instructs the actor to stand on the X 330 located in the middle of the floor, that the actor will have two 1-minute warm up sessions, and one 2-minute recorded audition. The number of warm-up sessions and recording time specified here is for illustration only and is not meant to limit the number of warm-up sessions or the practice or recording times. The audio voice informs the actor that the words to the selected script will appear on the video/teleprompter screen 310 near the camera. The subsequent countdown and recorded performance then occurs in a similar manner as described in the previous embodiment. In one embodiment, the casting director (or his assistants) who placed the script for audition, reviews all the performances of the actors and either selects one or holds further auditions from a selected few.

Performance—Talent Search—Comedian

For the talent search comedian service, an artist, in this case a comedian, again follows a similar payment and registration process as illustrated in the previous subject matter categories. The comedian selects the comedian category 162 from the menu system shown in FIG. 1b. However, unlike the previous subject matter categories, a comedian does not read a script or lyrics from the video/teleprompter screen 310, as shown in FIG. 3a, but instead records his or her own presentation. In one embodiment, the comedian is guided through the process by the audio voice of an image of two booking agents sitting at one end of a New York style comedy club. In one embodiment, a cleaning crew is working behind the agents and preparing the tables for the upcoming evening. The booking agents may encourage and challenge the comedian and say, “That's some funny stuff. Let's see how you do on-line. Grab a mike and hit the button.” The above images are only illustrations and are not meant to limit the scope of the invention in any way. The process can be made more enjoyable in a number of ways.

In one embodiment, when the performance is completed, the performer can preview his or her performance and decide whether to upload the performance to the website or to purchase another take and re-record his or her performance. In an alternative embodiment, an unknown artist first records three performances, then views each recording, and selects one for evaluation.

Referring to FIG. 4, the digital recordings are stored on the studio server 420 in the original media format (whichever format is conducive to quality recording while minimizing file size). The digital recordings from each studio server 420 are then uploaded to a main server at the studio site 440. In one embodiment, each video file is previewed by the studio operator to ensure no inappropriate material is uploaded and made available to the general public. The main server at the studio site 440 then re-encodes the recordings in a variety of formats and forwards the video file for placement onto streaming servers 410. For example, in one embodiment, the recorded performance is re-encoded to one or more different digital media files such that the performance can be viewed by a popular player including, but not limited to, Real Network's Real Player®, Apple's Quicktime®, and Microsoft's Windows Media® Player. The studio server 420 can connect and transmit video files to the main studio server at the studio site 440 in a number of ways, including, but not limited to cable, DSL, phone line, wireless, satellite connection, or in any other manner known to those in the art. The main server at the studio site 440 can connect to the streaming servers 410 in the same ways.

When an information seeker or viewer activates a link to the recording at the studio operator site 440 based on the category and sub-category (subject matter), the video is provided by a streaming server 410. Streaming servers 410 are used to minimize bandwidth used when information seekers 108 view the performances from a network such as the Internet. Streaming servers 410 are located throughout the world. Thus, when an information seeker 108 in, for example, the southeastern United States accesses a link to a recording on, for example, the studio operator website 440, the recording is downloaded to the information seeker 108 from the streaming server 410 nearest to the information seeker 108 who, in this example, is a viewer. Thus, a streaming server 410 in the southeastern United States will download the recording to the viewer 108 in the southeastern United States. The nearer a viewer or an information seeker 108 is to the streaming server 410, the less bandwidth is required. Akamai Technologies Inc. headquartered in Cambridge, Mass., provides such streaming servers 410. In one embodiment, each individual studio server 420 transmits at least one video for placement on a streaming server 410. In one embodiment, the studio operator site 440 is a website accessed via the Internet. In an alternative embodiment (not shown), the studio operator site is a “brick and mortar” physical location where recorded video images are sent and may be viewed by information seekers.

In one embodiment, after viewing the recording from the streaming server 410, a member of the general public will have an opportunity to rate the artist's work. In such an embodiment, a viewer will register the vote on the studio site 440. A ratings system well known in the art, such as the one utilized by www.ratings.net can be used.

When an unknown artist's ratings achieve a pre-determined threshold, an electronic notice, such as an email message may be automatically sent to the studio operator. The studio operator may then show those performances to interested talent seekers. The pre-determined threshold is set by the studio operator. To set the threshold, the studio operator specifies an average rating and a minimum number of votes a recording must achieve to surpass the threshold. Then, the interested talent seekers may bid against one another to learn the artist's identity to meet and discuss future potential business opportunities with the artist.

In one embodiment, talent seekers can register to be automatically notified when an artistic work in a specified sub-category, group of sub-categories, or categories exceeds a desired threshold. For example, a talent seeker may want to be notified when any artist in the country music category has an average rating of eight on a ten scale with at least 1,000 votes.

As discussed previously, the artist can be required to agree during registration to allow the studio operator to be the artist's exclusive agent. This is important to ensure that the artist is able to negotiate a fair deal when bargaining with sophisticated talent seekers.

The instant invention has numerous benefits to artists, talent seekers, and viewers that rate the artist's material. Viewers benefit in several ways. First, viewers would be supplied with free entertainment and a chance to review creative talents. Second, such entertainment could be viewed twenty-four hours a day, unlike television programs showing such talent, which are often only offered once a week and often at an inconvenient time. Third, a viewer could select to view performers in the categories the viewer was interested in viewing and rating.

This invention also has several advantages to talent seekers. First, talent seekers would have access to thousands of performers and could quickly narrow the field to find the type of artist the talent seeker needed or wanted to market. Second, it would be cost effective in that a certain level of popularity is ascertained through the ratings system before any money is spent by a talent seeker on such things as promotion and advertising. Third, talent seekers may review prospects from the comfort of their own offices or even homes. Fourth, talent seekers would have access to potentially thousands of aspiring, unknown artists who otherwise would not have had the opportunity to audition due to monetary or time constraints. Fifth, there would no longer be a need to promote, organize, or travel to and pay for expensive auditions. The instant invention thus provides an automatic filtering system and produces a steady flow of desired talent. Initial auditions for shows such as “American Idol” or “Nashville Star” could even be done using this invention giving consumers total choice, rather than leaving the initial selection up to a panel of judges, as is done in those shows.

This invention also has numerous advantages for the aspiring, unknown artists. First, in one embodiment, there would no pressure from audiences or bystanders because the performance would be in private in an enclosed studio. Thus, the artist would have the confidence and feeling he or she would have when they sing in the shower, for example. Second, the artist's assurance of his or her talent level would be high because it is potentially ascertained mostly by anonymous voters who do not know the artist and have no basis other than the artist's performance on which to base their rating. Third, this rating system eliminates any potential discrimination based on age, sex, race or color that could be exercised by a record label, casting company, or other talent seeking gatekeeper. Because so many people will be taking part in the ratings system, any votes based on preconceived prejudice are diluted in the overall voting. Fourth, the low cost of participation would make this affordable. No longer is there a need for expensive audio and/or video production for demo tapes and the associated copying and mailing costs. Fifth, each artist would have an equal chance of getting ratings as anyone else, and the opportunity would not be based upon the talent of a talent scout, but instead would be based only on the artist's talent. Sixth, the artist could perform at a time convenient and compatible with his or her schedule. Thus, this invention provides a significant improvement over prior art methods of enabling the artists or performers to further exploit their talents while also enabling lay people to view and rate aspiring, unknown artists or other performers.

While the invention has been predominately described as a method for ascertaining an unknown artist's musical talent or acting talent, the ascertainment of any talent can be achieved with this invention. For example, job applicants could interview in the studio by answering questions posed through the studio's audio system. Current employees or managers could view and rate the applicants at a time convenient to them and thereby determine those applicants that are offered live interviews. However, the instant invention is also useful for other subject matter categories and services where no ratings system is involved. Below are a few examples.

Presentation—Infomercial

As depicted by the menu of FIG. 1b, a studio user, using the presentation 160 service of the present invention, follows the same payment and registration process as discussed above, and enters the studio. As shown in FIG. 3c the studio user logs in at the computer terminal 220, selects a presentation category, obtains a receipt from the printer 222, enters the studio, scans the receipt at the bar code reader 320 and is instructed to stand on the X 330 located in the middle of the floor. The audio voice then informs the studio user that he or she will have a set amount of time, two minutes for example, to pitch his or her idea, service, product, or need. For example a magician may perform a magic act so that potential clients can preview his work. A businessman may want to show how his or her patent has the potential to produce substantial return. A salesman may have a product he or she wants to demonstrate and market to distributors. A child may make a personal plea for money required for a medical need. A politician could address an issue. The audio voice instructs the studio user on proceeding and commences a countdown as in the other embodiments. Again, the number of warm-up sessions and recording time specified in the previous embodiments is for illustration only and is not meant to limit the number or duration of warm-up sessions or the practice or recording times. In this embodiment, no music is transmitted through the headphones 324 and no lyrics are shown on the video/teleprompter screen 310. In one embodiment, as the studio user performs, the video/teleprompter screen 310 simultaneously shows his or her performance.

After the performance, the studio user may view the recording at the video/teleprompter screen 310, the performance review station 350 or may later access and view the recording from the studio site. In an alternative embodiment, the studio user may preview and then upload his or her recording to the studio website. In one embodiment, the studio user is informed that submission enables it to be viewed by Internet users or viewers who specify search criteria input during registration. In one embodiment, viewers do not rate the performance. Next, the audio voice may then remind the artist to visit the studio web site to finish his or her profile so his or her recording can be viewed by information seekers. In one embodiment, the recorded performance is directly accessible by a link from the studio user's own website. This enables studio users with websites (e.g. politicians) the ability to place video links on their website without expensive and difficult to use video recording equipment. In one embodiment, the studio user pays the studio operator a fee based on the number of times the recorded performance is accessed from the studio user's own website.

Interview—Job Category

To access the interview studio service, a studio user selects “interview” 180 from the main list of categories and “job” 182 from a sub-category list from the menu shown in FIG. 1b. The studio user or interviewee may then further narrow the search to the job listing field sub-categories in the database. Such sub-categories could be stored and categorized by job type or location. Alternatively, the interviewee may have already searched the jobs for which he or she is interested in interviewing for on the studio operator website or a studio-affiliated website for example. Additionally, the interviewee or studio user could be given a job code to input from an employer, a headhunter, or a newspaper advertisement.

Following payment, the interviewee registers at the registration and payment center provided on the outside of the studio. In one embodiment, the interviewee has been provided a third party billing code by an employer and submits the billing code at registration so the employer pays for the interview. In an alternative embodiment, an employer or other information seeker pre-registers the interviewee or studio user such that an interviewee simply submits a username and password or other uniquely identifying information during registration. This enables the interviewee to gain prepaid and/or pre-programmed access to the studio and its recording systems.

As described above, following registration, the payment and registration center 220, as shown in FIG. 4, inputs information to the studio server 420, payment information is verified, a profile is created and an account and future log-in information such as a user name and password is created. The payment and registration center 220 prints out the information along with a bar code. Next, the interviewee proceeds inside the studio to prepare for the interview.

As in the talent search service described above, upon entry into the studio 200 (FIG. 2), an audio voice instructs the studio user or interviewee how to proceed. For example, referring to FIG. 3b, the audio voice instructs the artist to, “please scan the bar code from the receipt obtained during registration.” Once the bar code is scanned at the bar code reader 320, the studio server 420 confirms the interviewee's log-in, and asks questions based on the job he or she is applying for. The audio voice informs the interviewee that he or she will be able to hear interview questions using the headphones 324 located on the wall as shown in FIG. 3b. In an alternative embodiment, interview questions are heard through a speaker inside the studio. The system may also instruct the interviewee to use a microphone 326 and to place the headphones 324 on his or her head. Next, the audio voice may prompt the interviewee to press the appropriate button on a control panel 332 when ready to start the performance. Then, the audio voice may instruct the artist to walk to the X 330 located in the middle of the studio. Next, the audio voice informs the interviewee to touch the appropriate button on the control panel 332. This activates a simultaneous audio countdown in the headphones 324 and a visual countdown on the video/teleprompter screen 310 next to the camera 312.

After the countdown, the interview questions are played in the headphones 324. Additionally, pictures or graphics may appear on the video/teleprompter screen 310. A personality test or spatial reasoning test could be incorporated into the interview. The interviewee could be given a set amount of time to answer each question and a countdown could shown on the video/teleprompter screen 310 as time elapses. Alternatively, after the interviewee is finished answering each question, he or she pushes the appropriate button on a control panel 332 to advance to the next question. In one embodiment, after the interviewee is finished answering a question, he or she can advance to the next question either physically, by accessing a button on the control panel 332 or remotely, for example by a voice-recognition system or other remote control device. In one embodiment, as the interviewee interviews, he or she simultaneously views his or her interview on a video/teleprompter screen 310.

In an alternative embodiment, the interview is conducted via live videoconferencing. Live video conferencing can be implemented in the disclosed invention by methods known in the art. Videoconferencing could be implemented by software available from WebEX™ (http://www.webx.com) of San Jose, Calif. or MCI® Video Conferencing Services (http://emeetings.mci.com). In one embodiment, videoconferencing occurs over the internet between at least two studio users in at least two studios. In this embodiment, one studio user could pre-register at the studio site 440 and reserve the studios in the desired locations and the desired time. In one embodiment, the video is transmitted such that at least 30 frames per second are sent to avoid staggered video. Videoconferencing would be useful in several other subject matter categories including, but not not limited to legal depositions, entrepreneur presentations, business meetings, and accident investigations for out-of-state parties.

Once the interview is finished, the audio voice may compliment the interviewee and inform the interviewee that his or her interview may be previewed at the video/teleprompter screen 310. Following the preview, the artist may submit his or her recorded interview to the studio site 440 where it can be accessed by information seekers as shown by FIG. 4. In one embodiment, the interviewee is informed that submission enables it to be viewed by potential co-workers who will rate the interview and give the interviewee a fair chance at becoming a fellow co-worker or obtaining an on-site interview. In an alternative embodiment, an interviewer directly views the recorded interview. An audio voice may then remind the artist to visit the studio site 440, as shown in FIG. 4, to finish his or her profile so his or her recording can be viewed and rated. Next, the audio voice thanks the interviewee and wishes him or her luck. The audio voice may also remind the studio user to return the headphones 324 and microphone 326 to the storage rack 322. An email may be sent to the interviewee informing or reminding her to visit and log-in to the studio site 440 to check the status of her interview.

Interview—Consumer Feedback

To take part in a consumer feedback service, a studio user accesses a menu similar to FIG. 1b, selects “interview” 180 from the main list of categories and “Consumer Feedback” 184 from a sub-category list. The studio user or consumer may then input a third party billing code, provided by the goods or service company that wants a particular good or service rated, into the payment and registration center 220. The company that has signed up for this service in advance is then billed for the session.

Next, the consumer registers and inputs requested demographic information that the goods or service provider deems relevant. As described above, following registration at the payment and registration center 220, as shown in FIG. 4, payment information is verified, a profile is created and an account and log-in information such as a user name and password is created. The payment and registration center 220 prints out the information along with a bar code and instructions. After payment and registration, the consumer will proceed inside the studio where his or her feedback is provided.

As in the performance services described above, upon entry into the studio 200, an audio voice instructs the consumer how to proceed. The audio voice informs the consumer that he or she will be able to hear interview questions using the headphones 324 located on the wall as shown in FIG. 3b. The system will also instruct the consumer to use a microphone 326 and to place the headphones 324 on his or her head. The consumer then proceeds to answer questions posed. The questions could be about upcoming products, movie ideas, commercials, political views, current events, songs, etc.

In one embodiment, once the interview is completed, the computer screen then reminds the consumer to visit the studio site to finish his or her profile so his or her recording can be viewed and a check or coupon for participation may be sent to the consumer for taking part in the feedback study. In an alternative embodiment, cash is dispensed directly from the payment and registration center 220.

Although not necessarily illustrated in the embodiments and services detailed above, there are numerous types of interview-style formats that are conducive to using the interactive personal service provider including, but not limited to, job placement, college admissions, consumer feedback on products or services, dating services, accident investigations, video depositions, legal case screenings, television show screenings, and polling. In addition, there are numerous types of presentation-style formats that are conducive to using the interactive personal service provider including, but not limited to, entrepreneur presentations, and sending messages to far away friends and family. Further, there are numerous types of performance-style formats that are conducive to using the interactive personal service provider including, but not limited to, talent searches for music, casting, modeling, comedians, or small business infomercials. For example, a magician could record a small business infomercial in the studio for viewers to view prior to procuring the magician's services. A seller could demonstrate his or her product. Again, the above examples are given as expressions of illustration and not limitation. In essence, this invention is useful anytime video communication is useful.

While this invention has been particularly shown and described with reference to a preferred embodiment, it would be understood by those skilled in the art the various changes in form and detail may be made therein without departing from the spirit and scope of the invention.

1. An interactive personal service provider for video communication having a studio comprising:
an audio and video recorder to record at least one performance thereby making a recorded performance;
at least one computer server for storing said recorded performance further comprising:
an audio and video player to preview said recorded performance; and
a database to receive input information from a studio user that relates to said recorded performance; and
a communication connection to transmit said recorded performance to a studio site maintained by a studio operator wherein said recorded performance is categorized and wherein said site enable a plurality of viewers to view said recorded performance.

2. The interactive service provider in claim 1 wherein said studio operator can query said database for criteria specified by an information seeker.

3. The interactive service provider in claim 1 wherein a viewer is restricted from viewing said input information of said studio user on said site.

4. The interactive service provider in claim 1 wherein said viewer purchases said recorded performance from a studio operator.

5. The interactive service provider in claim 1 wherein a professional media kit is produced from said input information and said recorded performance.

6. The interactive service provider in claim 1 wherein an information seeker can query said input information.

7. The interactive service provider in claim 1 wherein at least one information seeker bids to enter into contract negotiations with said studio user.

8. The interactive service provider in claim 1 wherein said recorded performance is reviewed by a personal coach.

9. The interactive service provider in claim 1 wherein said recorded performance comprises a Karaoke-style performance performed in said studio.

10. The interactive service provider in claim 1 wherein said studio is substantially soundproof.

11. The interactive service provider in claim 1 wherein said audio and video recorder enables said studio user to transmit only one recording from at least two performances recorded by said studio user in said studio.

12. The interactive service provider in claim 1 wherein said studio user electronically contracts with said studio operator for an exclusive agency contract for said recorded performance.

13. The interactive service provider in claim 1 wherein said studio site comprises a website.

14. The interactive service provider in claim 1 wherein a menu on said studio site lists subject matter and pre-determined main categories and sub-categories.

15. The interactive service provider in claim 1 wherein a menu on said studio site allows user created categories and sub-categories.

16. The interactive service provider in claim 1 further comprising a video conferencing capability.

17. The interactive service provider in claim 1 wherein said site further comprises a ratings means for enabling said viewer to rate said recorded performance wherein further said ratings means prohibits said viewer from rating said recorded performance more than once.

18. The interactive service provider in claim 17 wherein an information seeker is electronically notified when ratings from said viewers exceeds a pre-determined ratings threshold.

19. The interactive service provider in claim 18 wherein a studio operator is electronically notified when ratings from said viewers exceeds a predetermined ratings threshold.

20. A method for placing a performance of a studio user on a studio site, said method comprising the steps of:
a. providing a studio in a public locations wherein said studio comprises an audio and video recording capability;
b. recording a performance of a studio user in said studio onto a studio server thereby creating a recorded performance;
c. categorizing said recorded performance by subject matter in a database; and
d. making said recorded performance accessible from a studio site maintained by a studio operator.

21. The method in claim 20 wherein said database is queried for specific information prior to accessing said recorded performance at step e.

22. The method in claim 20 wherein information is input by said studio user prior to making said recorded performance accessible at step d.

23. The method in claim 22 further comprising a step of producing a professional media kit after step d.

24. The method in claim 20 wherein an information seeker purchases said performance.

25. The method in claim 20 further comprising a step of at least one information seeker bidding to enter into contract negotiations with said studio user.

26. The method in claim 20 further comprising a step of a personal coach reviewing said recorded performance after step d.

27. The method in claim 20 wherein said recording of said performance at step d comprises a Karaoke-style performance.

28. The method in claim 20 wherein said studio is substantially soundproof.

29. The method in claim 20 wherein said recorded performance at step b is repeated at least two times and said studio user selects only one recorded performance to be accessible at step c.

30. The method in claim 20 wherein said studio user agrees to an exclusive agency contract with a studio operator prior to step b.

31. The method in claim 20 wherein said studio site comprises a website.

32. The method in claim 20 wherein said categorizing of subject matter comprises classifying said recorded performance into subject matter comprising pre-determined main categories and sub-categories.

33. The method in claim 20 wherein said categorizing of subject matter comprises classifying said recorded performance into subject matter comprising user-determined main categories and sub-categories.

34. The method in claim 20 wherein said recorded performance comprises at least two studio users in at least two separate locations.

35. The method in claim 20 wherein said recorded performance may be rated after step d and wherein a plurality of viewers register with said studio site prior to rating said recorded performance and wherein further each said viewer is restricted from rating the same performance more than once.

36. The method in claim 35 wherein said studio operator is electronically notified when a performance exceeds a pre-determined ratings threshold.

37. The method in claim 35 wherein an information seeker is electronically notified when said recorded performance exceeds a pre-determined ratings threshold.

38. A method of recruiting talent comprising:
a. providing a studio in a public place for at least one studio user to record a performance;
b. recording said performance in said studio on a studio server thereby making a recorded performance;
c. transmitting said recorded performance to an information seeker

39. The method in claim 38 wherein said studio user further provides demographic information.

40. The method in claim 39 wherein a talent seeker may access said demographic information.

41. The method in claim 39 wherein said studio user pays a subscription to provide said demographic information.

42. The method in claim 39 wherein said talent seeker pays a subscription for access to said demographic information.

43. The method in claim 39 wherein said demographic information is transmitted to a talent seeker.

44. The method in claim 39 wherein a professional media kit is produced comprising said recorded performance and said demographic information.

45. The method in claim 38 wherein a personal coach reviews said recorded performance and provides feedback to said studio user.

46. The method of claim 38 wherein said recording of step b) is achieved in a Karaoke-style fashion whereby music is transmitted through at least one speaker inside said studio and words are displayed on a video/teleprompter screen.

47. The method in claim 38 wherein said recording of step b) is achieved in an interview fashion whereby questions are transmitted through at least one speaker.

48. The method in claim 38 wherein said video is rated.

49. The method in claim 38 wherein said information seeker at step c) further views said recorded performance from an internet connection.

50. The method in claim 38 wherein said recorded performance is categorized by subject matter.

51. An apparatus for distributing information to at least one information seeker said apparatus comprising:
at least two studio booths wherein each studio booth is equipped with an audio and video recording device and is located in a publicly accessible location; and
a studio site connected to each said studio booth wherein a plurality of studio users can access one of the plurality of said studio booths to upload a performance.

52. The apparatus in claim 51 wherein each booth further comprises at least one server.

53. The apparatus in claim 51 wherein the studio site comprises a website.

54. The apparatus in claim 53 wherein said information seeker can access a database on said website to view said performance.

55. The apparatus in claim 54 wherein said performance in said database is organized by subject matter.

56. The apparatus in claim 55 wherein said information seeker may rate said performance.

57. The apparatus in claim 54 wherein an information seeker queries said database.

58. The apparatus in claim 51 wherein said performance is sold to an information seeker.

59. The apparatus in claim 51 wherein at least two studio booths are located in different geographical locations.

60. The apparatus of claim 51 further comprising a live video conferencing capability.
